(19) United States
(12) Patent Application Publication
(10) Pub. No.: US 2024/0338549 A1
(43) Pub. Date: Oct. 10, 2024

(54) RFID TAG FOR LOW FREQUENCY AND HIGH FREQUENCY WITH METAL PROTECTION

(71) Applicant: Chih-Feng Lin, Hsinchu (TW)

(72) Inventor: Chih-Feng Lin, Hsinchu (TW)

(21) Appl. No.: 18/598,543

(22) Filed: Mar. 7, 2024

(30) Foreign Application Priority Data
Apr. 10, 2023 (TW) 112113367

(51) Int. Cl. G06K 19/077; G06K 19/07; H01Q 1/22; H01Q 7/00

(52) U.S. Cl. CPC G06K 19/07728; G06K 19/0723; G06K 19/07773; H01Q 1/2208; H01Q 7/00

(57) ABSTRACT

An RFID tag for high frequency (HF) or low frequency (LF) with metal protection is provided, including: an electronic tag, a metal protective piece and an insulator. The electronic tag includes a loop antenna and a control chip set electrically connected thereto; the metal protective piece is arranged around the loop antenna shape and is a non-closed ring-shaped metal piece; the insulator covers the electronic tag and is fixed on the metal protective piece, and the insulator prevents the loop antenna and the metal protective piece from contacting with each other; the control chipset is pre-adjusted so that the loop antenna and the metal protective piece are at the same operating frequency. The non-closed ring-shaped metal protective piece protects the electronic tag so that it is not easily damaged, and can be used to sense HF or LF signals.

### CROSS-REFERENCE TO RELATED APPLICATION

This application claims the priority of Taiwanese patent application No. 112113367, filed on Apr. 10, 2023, which is incorporated herewith by reference.

### BACKGROUND OF THE INVENTION

### 1. Field of the Invention

The present invention relates generally to an RFID tag for low frequency and high frequency, and more particularly, to an RFID with metal protection.

### 2. The Prior Arts

In recent years, electronic payment has been widely used in various consumer payments, and the most common ones are payment applications that use smart phones as tools. In general, electronic payment currently on the market is a communication security technology based on Radio-Frequency Identification (RFID)/near field communication (NFC) technology, wherein RFID has a wider range of applications than the NFC. In addition to electronic payment, RFID tags can also be used for short-distance access control sensing. Therefore, many products with RFID tags are provided, such as cards, access cards, small pendants with electronic payment, etc.

For RFID tags used in low frequency (LF) or high frequency (HF), if a metal plate is completely covered on the receiving surface of the RFID tag in order to increase the strength, the electromagnetic wave of the received signal will generate eddy current on the surface of the metal plate. Eddy currents reflect the incoming electromagnetic waves or generate reverse electromagnetic waves to hinder the reception/transmission of signals, which renders such metal-coated RFID tags unable to sense. Therefore, manufacturers have designed different structures to address this issue, but the common approach is to reduce the metal shielding range, the overall rigidity will also be compromised. Therefore, the present invention aims to maximize the metal shielding range, while maintaining the normal operation of the RFID tag at LF or HF and using metal features to improve structural rigidity, impact resistance, and resistance to damage, thereby increasing the product's application range.

### SUMMARY OF THE INVENTION

A primary objective of the present invention is to provide an RFID tag for low frequency (LF) or high frequency (HF) with metal protection, which mainly utilizes a non-closed ring-shaped metal protective piece to correspond to the loop antenna of the internal electronic tag. When the external transmitter (i.e., the reader) emits an electromagnetic wave signal, the metal protective element is affected by the eddy current generated by induction but the eddy current cannot form a loop to hinder the internal electronic tag's receiving/transmitting signals. The RFID tag comprises a metal protective part to provide the advantages of durability and long service life.

In order to achieve the aforementioned objects, the present invention adopts the following technical solutions.

The present invention provides an RFID tag for low frequency (LF) or high frequency (HF) with metal protection, comprising: an electronic tag, a metal protective piece, and an insulator; wherein the electronic tag comprising a loop antenna and a control chip set electrically connected to the loop antenna; the metal protective piece being arranged around the loop antenna to form a non-closed ring-shaped metal piece; the insulator covering the electronic tag and being fixed to the metal protective piece so that the insulator keeping the loop antenna and the metal protective piece from contacting with each other; the control chip set being pre-adjusted so that the loop antenna and the metal protective piece operating at the same operating frequency.

In a preferred embodiment, the metal protective piece is a tube and has an interrupting gap to form a non-closed loop; the loop antenna is disposed in the tube and is maintained by the insulator from contacting the metal protective piece.

In a preferred embodiment, the metal protective piece has annularly distributed openings along an unsealed annular tube wall.

In a preferred embodiment, the metal protective piece has a U-shaped or C-shaped longitudinal cross-section, the entirety of the metal protective piece forms a non-closed ring, the loop antenna is arranged in a concave area of the U-shaped or C-shaped cross-section, and the insulator keeps the metal protective piece and the loop antenna from contacting.

In a preferred embodiment, the metal protective piece is in a shape of a sheet and corresponds to the shape of the loop antenna, and the metal protective piece is a non-closed ring-shaped piece.

In a preferred embodiment, a protective sleeve is provided around the metal protective piece, the protective sleeve covers peripheries of the interrupting gaps, and the protective sleeve is made of insulating material.

In a preferred embodiment, when the protective sleeve is made of metal, an insulating layer is provided between the protective sleeve and the metal protective piece.

In a preferred embodiment, a protective ring is also provided, the protective ring is engaged to the opening position of the metal protective piece to seal the opening, and the protective ring is made of insulating material.

In a preferred embodiment, a protective ring is also provided, the protective ring is made of metal and is in a non-closed ring shape, the protective ring is engaged to the metal protective piece to seal the opening, and an insulating layer is provided between the protective ring and the metal protective piece.

In a preferred embodiment, the metal protective piece has a non-closed ring shape and is divided into a first section and a second section at both ends, the first section and the second section partially overlap but are insulated from each other by an insulating layer.

In a preferred embodiment, the metal protective piece has a tubular non-closed ring shape, and has annularly distributed openings along the non-closed annular tube wall.

In a preferred embodiment, the metal protective piece is a tubular non-closed ring, the second section is inserted into the first section, and the first section and the second section are not in contact.

Compared with the prior art, the present invention has the following specific effects:
1. The RFID tag comprises a non-closed ring-shaped metal protective piece, which is sturdy and durable; therefore, the present invention can be used in outdoor environments and resistant to wind and rain to provide a long service life.
2. The metal protective piece made of metal materials has a variety of shell types to choose from, such as tubular, U-shaped, C-shaped or sheet-shaped non-closed rings, allowing for more product types and a wider range of applications.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of the first embodiment of the present invention.

FIG. 2 is an enlarged cross-sectional view of the first embodiment of the present invention.

FIG. 3 is a circuit diagram of the first embodiment of the present invention.

FIG. 4 is a perspective view of the second embodiment of the present invention.

FIG. 5 is an enlarged cross-sectional view of the interrupting gap position in the second embodiment of the present invention.

FIG. 6 is a perspective view of the third embodiment of the present invention.

FIG. 7 is an enlarged cross-sectional view of the third embodiment of the present invention.

FIG. 8A is another schematic cross-sectional view of the metal protective piece in the third embodiment of the present invention.

FIG. 8B is another schematic cross-sectional view of the metal protective piece in the third embodiment of the present invention.

FIG. 8C is another schematic cross-sectional view of the metal protective piece in the third embodiment of the present invention.

FIG. 9 is a perspective view of the fourth embodiment of the present invention.

FIG. 10 is an enlarged cross-sectional view of the fourth embodiment of the present invention.

FIG. 11 is a perspective view of the fifth embodiment of the present invention.

FIG. 12 is an enlarged cross-sectional view of the interrupting gap position in the fifth embodiment of the present invention.

FIG. 13 is a perspective view of the sixth embodiment of the present invention.

FIG. 14 is an exploded view of the sixth embodiment of the present invention.

FIG. 15 is a first schematic view of the actual use of the present invention.

FIG. 16 is a second schematic view of the actual use of the present invention.

FIG. 17 is a perspective view of the seventh embodiment of the present invention.

FIG. 18 is a cross-sectional view of the seventh embodiment of the present invention.

### DETAILED DESCRIPTION OF THE PREFERRED EMBODIMENT

The technical solutions of the present invention will be described clearly and completely below in conjunction with the specific embodiments and the accompanying drawings. It should be noted that when an element is referred to as being “mounted or fixed to” another element, it means that the element can be directly on the other element or an intervening element may also be present. When an element is referred to as being “connected” to another element, it means that the element can be directly connected to the other element or intervening elements may also be present. In the illustrated embodiment, the directions indicated up, down, left, right, front and back, etc. are relative, and are used to explain that the structures and movements of the various components in this case are relative. These representations are appropriate when the components are in the positions shown in the figures. However, if the description of the positions of elements changes, it is believed that these representations will change accordingly.

Unless otherwise defined, all technical and scientific terms used herein have the same meaning as commonly understood by one of ordinary skill in the art of the present invention. The terminology used herein is for the purpose of describing particular embodiments only and is not intended to limit the present invention. As used herein, the term “and/or” includes any and all combinations of one or more of the associated listed items.

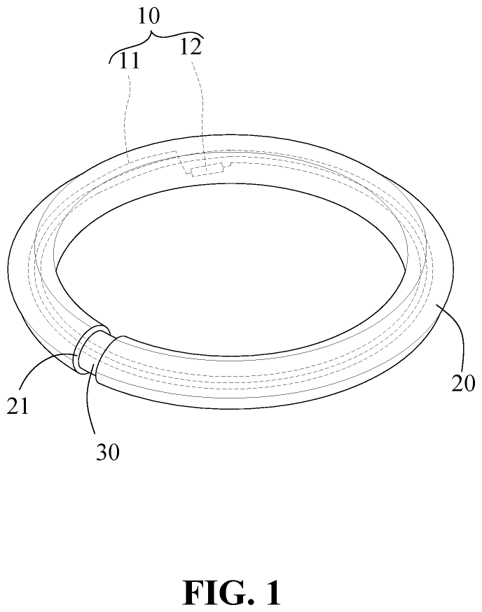

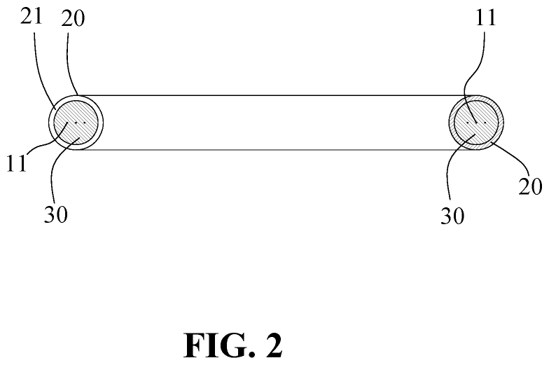

FIGS. 1 and 2 are respectively a perspective view and a cross-sectional view of the first embodiment of the RFID tag for low frequency (LF) or high frequency (HF) with metal protection according to the present invention. The RFID tag with metal protection of the present invention includes: an electronic tag 10, a metal protective piece 20, and an insulator 30. The electronic tag 10 includes a loop antenna 11 and a control chip set 12 electrically connected thereto; the metal protective piece 20 is arranged around the loop antenna 11 and is a non-closed ring-shaped metal piece. In the present embodiment, The metal protective piece 20 has an interrupting gap 21 to form a non-closed ring shape; the insulator 30 covers the periphery of the electronic tag 10 and is fixed onto the metal protective piece 20, and the loop antenna 11 and the metal protection are kept from contacting by the insulator 30; the control chip set 12 is pre-adjusted so that the loop antenna 11 and the metal protective piece 20 are operating at the same operating frequency.

When an external emitter (i.e., a reader) emits an electromagnetic wave signal, the metal protective piece 20 will generate an eddy current on the metal surface when the electromagnetic wave is transmitted to the metal surface. The technology of the present invention utilizes the interrupting gap 21 to prevent the eddy current from forming a loop, so that the electromagnetic wave will not be completely reflected, but a part of the electromagnetic wave will be allowed to pass. Because the metal protective piece 20 will also generate a corresponding electromagnetic field corresponding to the electronic tag 10 and due to the pre-adjustment, the electronic tag 10 senses and returns the data stored in the electronic tag 10, so that the electronic tag 10 of the present invention can be used in a high frequency (HF) environment (for example: 13.56 MHz) or a low frequency (LF) environment (for example: 125 KHz).

The following gives a detailed description of each component:

The electronic tag 10 includes a loop antenna 11 and a control chip set 12 electrically connected thereto. The loop antenna 11 is basically a structure in which a metal conductor is wound into a certain shape, such as a circle, a square, a triangle, etc., with both ends of the conductor as the output end. However, in order to increase the reception intensity, it is usually wound in multiple turns (such as Helical or overlapping) multi-turn loop antenna. The electronic tag 10 is a passive electronic tag that stores user information. In the present embodiment, the electronic tag 10 transmits and receives user information through radio-frequency identification (Radio-Frequency Identification, RFID) technology that operates without power. In general, RFID technology that operates without power generally uses magnetic fields for electromagnetic induction. In the present embodiment, the electronic tag 10 has a multi-turn loop antenna 11. The loop antenna 11 inside the passive electronic tag 10 is used for electromagnetic induction from magnetic field provided by the outside device to generate voltage, so that the electronic tag 10 receives power to operate.

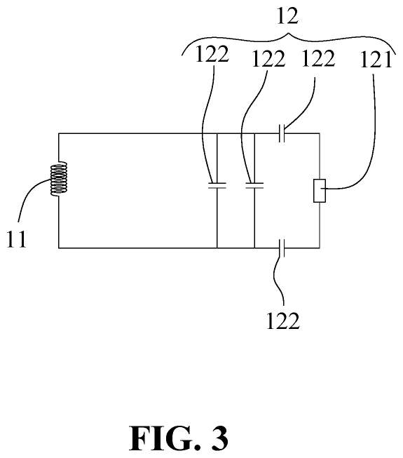

Refer to FIG. 3 for a circuit diagram of the present invention. The control chip set 12 includes a chip 121 and at least one capacitor 122. The chip 121 is coupled to the capacitor 122. The chip 121 is used for storing and modulating user information. It should be further explained that since the electronic tag 10 in the present implementation is a passive electronic tag that transmits and receives user information through RFID technology that operates without power supply, the signal power received by the loop antenna 11 must be effectively transmitted to the chip. 121, so that the chip 121 can obtain enough power to operate normally; and in order to achieve maximum power transmission, the input impedance of the loop antenna 11 must be conjugate matched with the input impedance of the chip 121. In the present embodiment, there is a plurality of capacitors 122, and the chip 121 and the plurality of capacitors 122 are connected in series or in parallel. However, this is only one embodiment of the present invention and is not limited thereto. The capacitor 122 is used to adjust the impedance matching between the loop antenna 11 and the chip 121, and also to adjust the loop antenna 11 and the metal protective piece 20 to operate at the same frequency.

The metal protective piece 20 maintains the rigidity of the structure, but does not affect the internal electronic tag 10 from receiving the electromagnetic wave signal emitted by the external transmitter (i.e., the reader). In the present invention, the metal protective piece 20 is arranged around the loop antenna 11 and has an interrupting gap 21 to form a non-closed ring shape. In the present embodiment, the metal protective piece 20 is tube and has a non-closed ring shape. The tubular metal protective piece 20 allows the loop antenna 11 to be disposed in the tube in a concentric circle. The insulator 30 prevents the loop antenna 11 from contacting the metal protective piece 20 and the insulator 30 also fixes the electronic tag 10 in the tubular metal protective piece 20. The insulator 30 can be an insulating film formed around the loop antenna 11 and then fixed in the metal protective piece 20 with adhesive. In the present embodiment, the insulator 30 is an insulating glue, which can fill the interrupting gap 21, protect the loop antenna 11, and prevent the interrupting gap 21 from easily breaking.

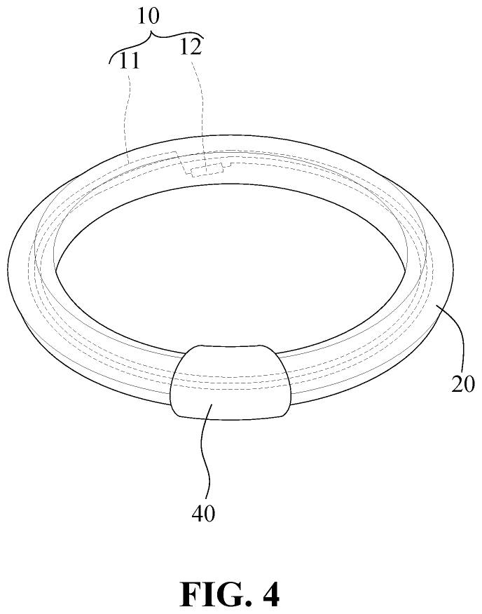

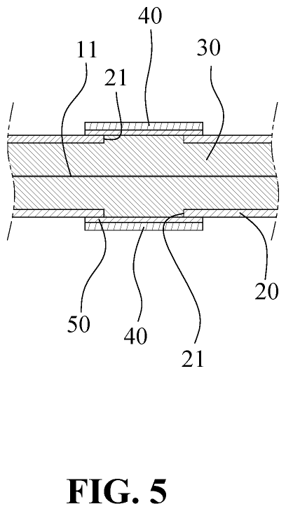

FIGS. 4 and 5 are respectively a perspective view and a partial cross-sectional view of the second embodiment of the present invention. The present embodiment still includes an electronic tag 10, a metal protective piece 20, and an insulator 30. The difference is that a protective sleeve 40 is provided. The protective sleeve 40 is tubular and is placed around the metal protective piece 20. As shown in FIG. 5, the protective sleeve 40 is wrapped around the interrupting gap 21. The protective sleeve 40 is made of hard material to protect and increase the strength of the non-closed ring-shaped tubular metal protective piece 20. However, it should be noted that in order to avoid affecting the induction of the electronic tag 10, the protective sleeve 40 is made of hard insulating material, such as plastic. If the protective sleeve 40 is made of metal, as shown in FIG. 5, an insulating layer 50 must be provided between the protective sleeve 40 and the metal protective piece 20. The insulating layer 50 can be an insulating adhesive or an insulating plastic gasket. Alternatively, an insulating film layer can be formed on the metal surface by anodizing.

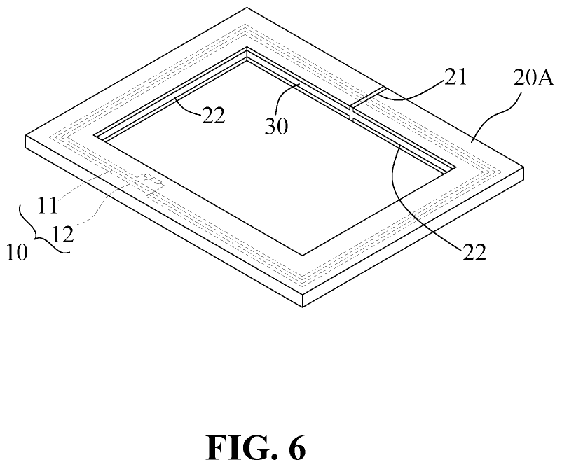

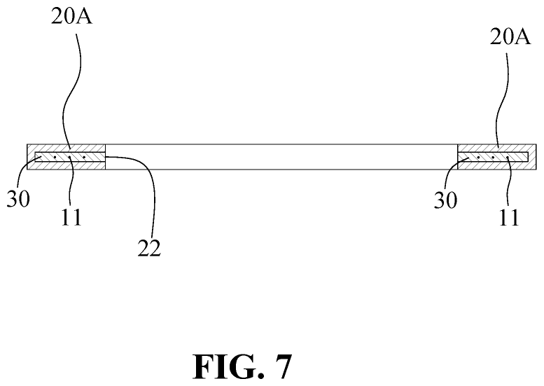

FIGS. 6 and 7 show a third embodiment of the present invention. The present embodiment still includes the electronic tag 10, the metal protective piece 20A and the insulator 30. The present embodiment mainly changes the shape of the metal protective piece 20A. The metal protective piece 20A is still formed by the interrupting gap 21 into an unclosed annular rectangular tube, and has annularly distributed openings 22 along the unclosed annular tube wall, as shown in FIG. 7. In the present embodiment, the metal protective piece 20A has a longitudinal section of U-shape, but it is not limited thereto. For example, the longitudinal section of the metal protective piece 20A can also be C-shaped. This structure is to enable the loop antenna 11 and the control chip set 12 to be pre-processed and coupled into the electronic tag 10, and the metal protective piece 20A has a U-shaped longitudinal section so that the loop antenna 11 can be easily placed through the opening 22 into the U-shaped recessed area, the insulator 30 finally prevents the metal protective piece 20A from contacting the loop antenna 11.

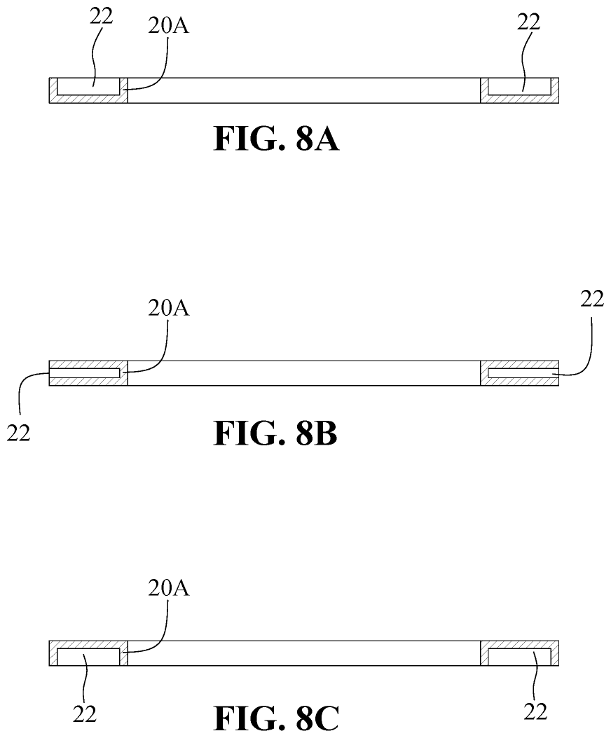

In addition, FIGS. 8A, 8B and 8C show different embodiments of the metal protective piece 20A of the present invention, mainly with openings 22 having different directions. For example, the opening 22 of the metal protective piece 20A in FIG. 8A gaces upward, the opening 22 of the metal protective piece 20A in FIG. 8B faces the peripheral direction, and the opening 22 of the metal protective piece 20A in FIG. 8C faces downward. In addition, the ring shape of the metal protective piece 20A is not limited to the four-sided ring shape of the present embodiment, and may also be a circular ring shape or a polygonal ring shape. In addition, in the embodiment of FIG. 8A and FIG. 8C, since the opening 22 faces upward or downward, the insulator 30 can be made of a printed circuit board, and the metal circuit formed by processing forms the loop antenna 11, and the control chip set 12 is also mounted on a printed circuit board. During assembly, the printed circuit board is directly placed in the opening 22 and then bonded, thereby achieving fast and convenient production.

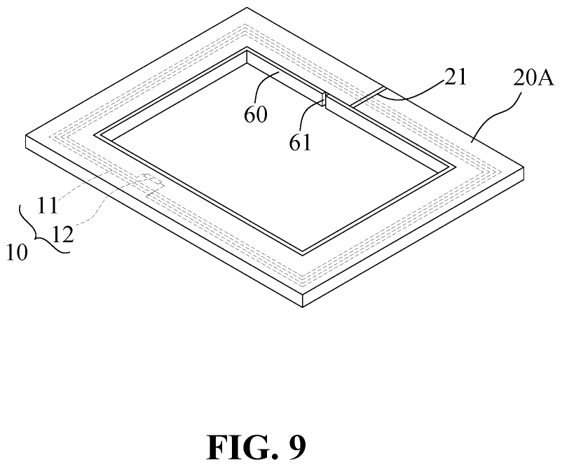

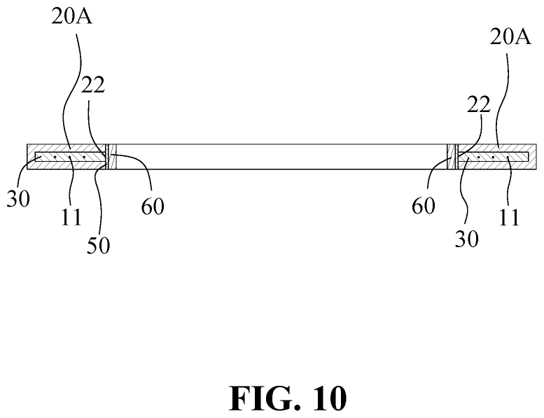

FIG. 9 is a perspective view of the fourth embodiment of the present invention. This implementation is similar to the third embodiment, except that a protective ring 60 is provided. As shown in FIG. 10, the function of the protective ring 60 is mainly to close the opening 22 as well as to increase the strength of the metal protective piece 20A. The protective ring 60 is made of hard material, but it should be noted that in order to avoid affecting the induction of the electronic tag 10, the protective ring 60 can be made of hard insulating material. If the protective ring 60 is made of metal, it must have a gap 61 to form a non-closed ring shape, and as shown in FIG. 10, an insulating layer 50 must be provided between the protective ring 60 and the metal protective piece 20A. The insulating layer 50 may be, for example, insulating adhesive, insulating plastic gasket, etc.

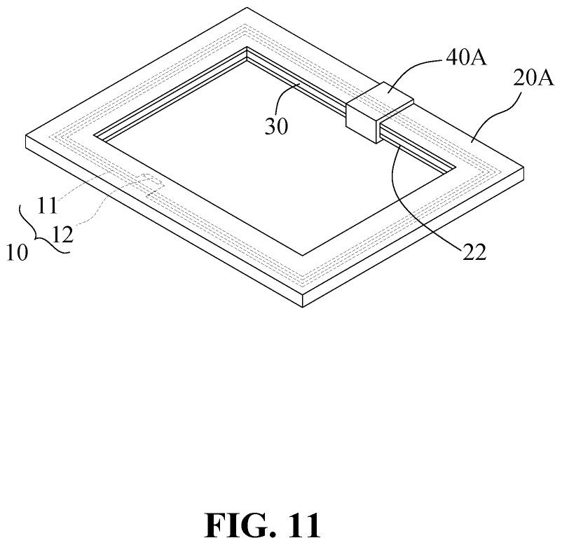

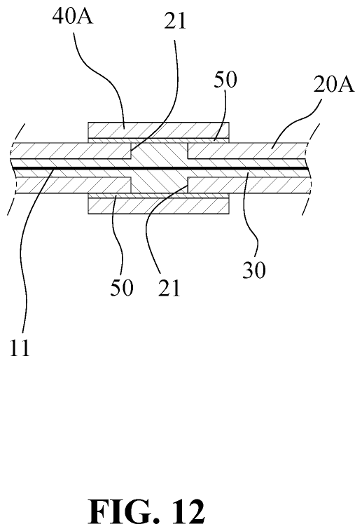

FIG. 11 is a perspective view of the fifth embodiment of the present invention. This implementation is similar to the third embodiment, except that a protective sleeve 40A is provided, and the protective sleeve 40A is placed on the metal protective piece 20A peripherally, as shown in FIG. 12. The protective sleeve 40A covers the periphery of the interrupting gap 21. The protective sleeve 40A is made of hard material to protect and increase the strength of the metal protective piece 20A at the interrupting gap 21. However, it should be noted that in order to avoid affecting the induction of the electronic tag 10, the protective sleeve 40A is made of hard insulating material. If the protective sleeve 40A is made of metal, as shown in FIG. 12, an insulating layer 50 is provided between the protective sleeve 40A and the metal protective piece 20A. In addition, in the present embodiment, the longitudinal section of the protective sleeve 40A is U-shaped, but it is not limited thereto. The protective sleeve 40A can also be in the shape of a square hollow tube.

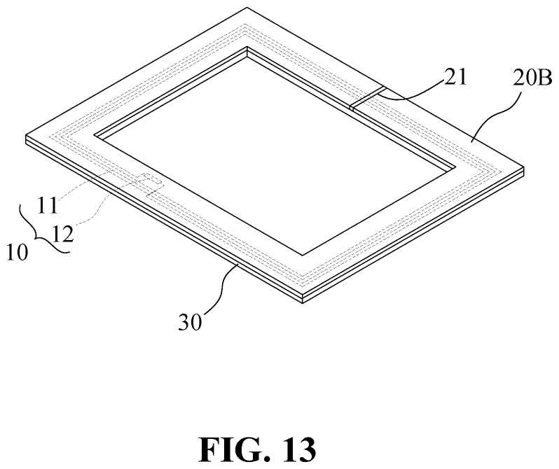

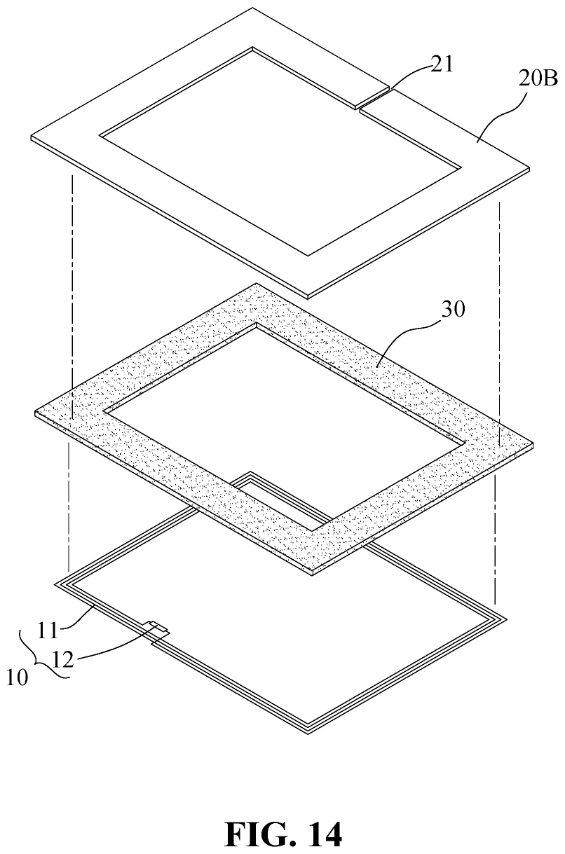

FIGS. 13 and 14 are respectively a perspective view and an exploded view of the sixth embodiment of the present invention. The main improvement in the present embodiment is the shape of the metal protective piece 20B. In the present embodiment, the metal protective piece 20B is in a sheet shape and corresponds to the shape of the loop antenna 11. The metal protective piece 20B has an interrupting gap 21 and forms a non-closed annular sheet. The insulator 30 covers the periphery of the electronic tag 10 and is fixed on the lower surface of the metal protective piece 20B. The insulator 30 prevents the loop antenna 11 from contacting the metal protective piece 20B. Of course, the insulator 30 can also be a printed circuit board having a metal wire on the surface to form the loop antenna 11 and a control chip set 12 to form the electronic tag 10.

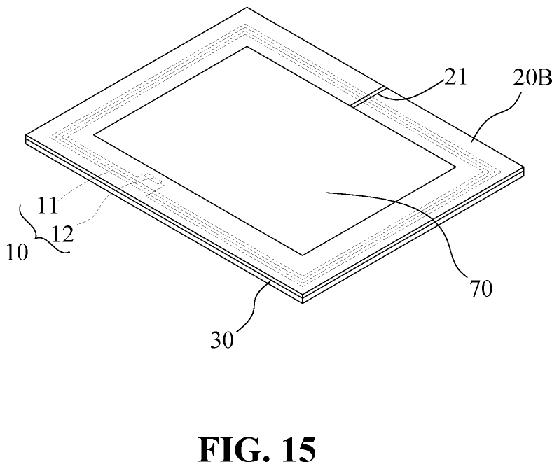

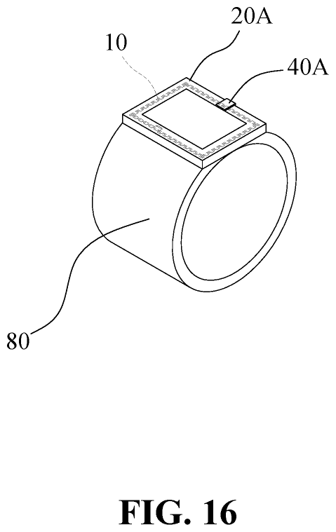

FIGS. 15 and 16 are schematic views of the actual use of the present invention. In FIG. 15, the metal protective piece 20B is added with a decoration 70 in the non-closed ring-shaped central area. The decoration 70 is preferably made of insulating plastic material. Drawings on the surface of the decoration 70 can increase the esthetics and usability convenience. In addition, if the decoration is made of metal, an insulating layer must be provided between the decoration and the metal protective component. In addition, as shown in FIG. 16, the metal protective piece 20A can also be installed on a bracelet 80 or a metal watch, thereby allowing the user to wear the RFID tag of the present invention on the hand to increase the applicable range of the product. In addition, in the first embodiment and the second embodiment, the present invention can be worn directly on the wrist as a bracelet. Therefore, the RFID tag with metal protection of the present invention can be applied to various products or combined with various accessories.

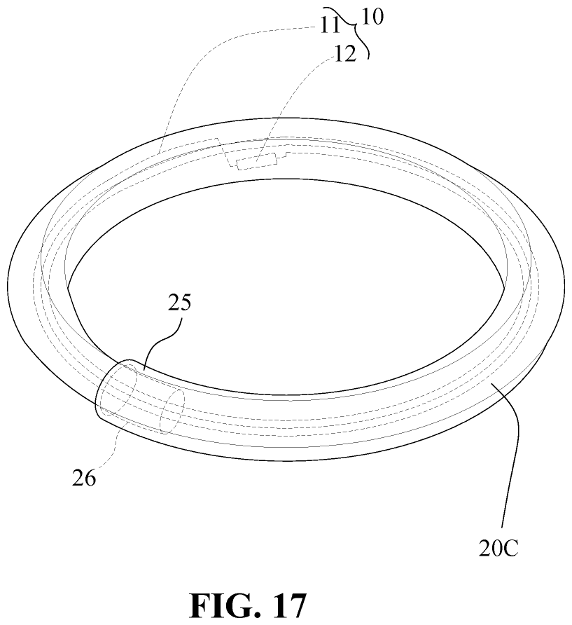

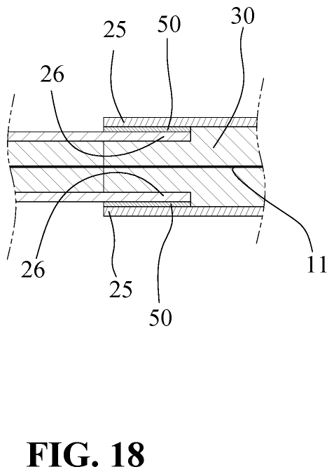

FIGS. 17 and 18 show a seventh embodiment of the present invention. In this implementation, the electronic tag 10, the metal protective piece 20C and the insulator 30 are still included. The main difference is that the shape of the metal protective piece 20C is improved. In the present embodiment, the metal protective piece 20C is a non-closed ring, with both ends as a first section 25 and a second section 26 respectively. Although the first section 25 and the second section 26 are partially overlapped, an insulating layer 50 is provided between the first section 25 and the second section 26 so that the two sections are not in contact. In the present embodiment, since the metal protective piece 20C is tubular, the second section 26 is inserted into the first section 25 to achieve a partial overlap effect, and the insulating layer 50 made of insulating adhesive or insulating plastic gasket prevents the two sections from contacting each other. In the present embodiment, the metal protective piece 20C is in a non-closed ring shape, so the eddy current generated during induction cannot form a loop. The advantage of the present embodiment is that the overall structure is closer to a closed ring shape, so the structure has better rigidity, unlike the previous implementation where the position of the interrupting gap 21 might have insufficient strength. In addition, some previous embodiments can also be applied to the present embodiment. For example, the metal protective piece 20C can also have annularly distributed openings along the non-closed annular tube wall, that is, the longitudinal section of the metal protective piece 20C can be U-shaped, or C-shaped; also, the metal protective piece 20C can also be in the shape of a sheet-like non-closed ring.

In summary, the RFID tag for low frequency (LF) or high frequency (HF) with metal protection of the present invention configures the non-closed ring-shaped metal protective piece 20 around the loop antenna 11. In a non-closed ring structure, when an external transmitter (i.e., a reader) emits an electromagnetic wave signal, the metal protective piece 20 is subject to the induced eddy current, but the eddy current cannot form a loop, so the electronic tag inside can be 10 receives or sends signals. As such, the metal protective piece 20 of the bracelet can provide excellent rigidity, has the advantages of impact resistance, and is not easily damaged. Therefore, the present invention is extremely convenient to use and is a design that is both practical and innovative.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. An radio-frequency identification (RFID) tag for low frequency (LF) or high frequency (HF) with metal protection, comprising:
an electronic tag, comprising a loop antenna and a control chip set electrically connected to the loop antenna;
a metal protective piece, arranged around the loop antenna to form a non-closed ring-shaped metal piece; and
an insulator, covering the electronic tag and being fixed to the metal protective piece so that the insulator keeping the loop antenna and the metal protective piece from contacting with each other;
wherein the control chip set being pre-adjusted so that the loop antenna and the metal protective piece operating at the same operating frequency.

2. The RFID tag for LF or HF with metal protection according to claim 1, wherein the metal protective piece is a tube and has an interrupting gap to form a non-closed loop; the loop antenna is disposed in the tube and is maintained by the insulator from contacting the metal protective piece.

3. The RFID tag for LF or HF with metal protection according to claim 2, wherein a protective sleeve is provided around the metal protective piece, the protective sleeve covers periphery of the interrupting gap, and the protective sleeve is made of insulating material.

4. The RFID tag for LF or HF with metal protection according to claim 2, wherein a protective sleeve is provided around the metal protective piece, the protective sleeve covers periphery of the interrupting gap, the protective sleeve is made of metal, and an insulating layer is provided between the protective sleeve and the metal protective piece.

5. The RFID tag for LF or HF with metal protection according to claim 2, wherein the metal protective piece has annularly distributed openings along an unsealed annular tube wall.

6. The RFID tag for LF or HF with metal protection according to claim 5, wherein the metal protective piece has a U-shaped or C-shaped longitudinal cross-section, the entirety of the metal protective piece forms a non-closed ring, the loop antenna is arranged in a concave area of the U-shaped or C-shaped cross-section, and the insulator keeps the metal protective piece and the loop antenna from contacting.

7. The RFID tag for LF or HF with metal protection according to claim 5, wherein a protective ring is also provided, the protective ring is engaged to the opening position of the metal protective piece to seal the opening, and the protective ring is made of insulating material.

8. The RFID tag for LF or HF with metal protection according to claim 5, wherein a protective ring is also provided, the protective ring is engaged to the opening position of the metal protective piece to seal the opening, and the protective ring is made of metal, and an insulating layer is provided between the protective ring and the metal protective piece.

9. The RFID tag for LF or HF with metal protection according to claim 5, wherein a protective sleeve is provided around the metal protective piece, the protective sleeve covers periphery of the interrupting gap, the protective sleeve has a shape matching the metal protective piece and has a cross-section of one of the U-shape, C-shape, or tubular shape, and the protective sleeve is made of insulating material.

10. The RFID tag for LF or HF with metal protection according to claim 5, wherein a protective sleeve is provided around the metal protective piece, the protective sleeve covers periphery of the interrupting gap, the protective sleeve has a shape matching the metal protective piece and has a cross-section of one of the U-shape, C-shape, or tubular shape, and the protective sleeve is made of metal and an insulating layer is provided between the protective sleeve and the metal protective piece.

11. The RFID tag for LF or HF with metal protection according to claim 1, wherein the metal protective piece is in a shape of a sheet and corresponds to the shape of the loop antenna, and the metal protective piece is a non-closed ring-shaped piece.

12. The RFID tag for LF or HF with metal protection according to claim 1, wherein the metal protective piece has a non-closed ring shape and is divided into a first section and a second section at both ends respectively, the first section and the second section partially overlap but are insulated from each other by an insulating layer.

13. The RFID tag for LF or HF with metal protection according to claim 12, wherein the metal protective piece has a tubular non-closed ring shape, and has annularly distributed openings along the non-closed annular tube wall.

14. The RFID tag for LF or HF with metal protection according to claim 12, wherein the metal protective piece is a tubular non-closed ring, the second section is inserted into the first section, and the first section and the second section are not in contact.
